(19) United States
(12) Patent Application Publication
(10) Pub. No.: US 2025/0385363 A1
(43) Pub. Date: Dec. 18, 2025

(54) BATTERY MODULE

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/187,207

(22) Filed: Apr. 23, 2025

(30) Foreign Application Priority Data
Jun. 12, 2024 (KR) 10-2024-0076566
Feb. 11, 2025 (KR) 10-2025-0017453

(51) Int. Cl. H01M 50/242; H01M 50/211; H01M 50/289; H01M 50/503; H01M 50/507

(52) U.S. Cl. CPC H01M 50/242; H01M 50/211; H01M 50/289; H01M 50/503; H01M 50/507

(57) ABSTRACT

Disclosed is a battery module including a battery stack including a plurality of battery cells stacked in a first direction, and one or more pad members provided between the plurality of battery cells. The battery module further includes at least one holder member provided at one side of the battery stack in a second direction, wherein the second direction intersects the first direction. A busbar may be coupled to the holder member and electrically connected to the battery stack. The battery module also includes an end cap member provided outward of the holder member in the second direction. Moreover, side plates are provided (e.g., respectively) at (e.g., two) opposite sides of the battery stack in the first direction. The holder member is provided to be in contact with the side plate.

### CROSS-REFERENCE TO RELATED APPLICATIONS

This application claims priority to and the benefit of Korean Patent Application No. 10-2024-0076566 filed in the Korean Intellectual Property Office on Jun. 12, 2024, and Korean Patent Application No. 10-2025-0017453 filed in the Korean Intellectual Property Office on Feb. 11, 2025, the entire contents of which are incorporated herein by reference.

### TECHNICAL FIELD

The present disclosure relates to a battery module, and further relates to a battery module including a pouch-type battery cell.

### BACKGROUND

In order to satisfy the marketability of battery modules mounted in electric vehicles, battery modules should charge sufficiently with electrical energy in a short (e.g., reduced) amount of time. Further, it is useful for the battery to have a temperature within an appropriate range during an operating process of the battery module.

In a case that the battery module is mounted in the electric vehicle, the battery module is often exposed to an impact or vibration caused by an external force, and the battery module may be damaged (or may swell) due to an impact applied to battery cells in the battery module. In addition, because of the nature of a cell lead fixed to a busbar, the cell lead may not accommodate an increase in thickness of the battery cell when the thickness of the battery cell increases as the battery cell swells, which causes an excessive load to be applied to the cell lead.

### SUMMARY

The present disclosure is provided to prevent damage to a battery module caused by vibration and impact caused by an external force and minimize a load applied to a cell lead, thereby improving (e.g., overall) durability of the battery module.

One aspect of the present disclosure provides a battery module including a battery stack including a plurality of battery cells stacked in a first direction D1, and one or more pad members provided between the plurality of battery cells, holder members provided at one (e.g., a first) side of the battery stack in a second direction D2 intersecting the first direction D1. Busbars may be assembled to the holder members and electrically connected to the battery stack. The battery module also includes an end cap member provided outward of the holder member in the second direction D2, and at least one side plate provided at a side (e.g., a second side) of the battery stack in the first direction D1, in which the holder member is provided to be in contact with the side plate. Further, the battery module may include at least two side plates provided respectively at two opposite sides of the battery stack in the first direction D1.

One side of the holder member may be fixedly coupled to the side plate.

At least one region of the holder member may be provided inward of the side plate in the second direction D2. The holder member may have a holder protruding portion protruding in the first direction D1 and provided in a region of the holder member provided inward of the side plate in the second direction D2. The side plate may have a side recessed portion having a recessed shape and provided in a region of an inner surface of the side plate provided in the first direction D1 and provided to face the holder protruding portion, and the holder protruding portion may be provided (e.g., accommodated) in the side recessed portion.

The side plates may include a first side plate provided at one side of the battery stack in the first direction D1 and including the side recessed portion, and a second side plate provided at the other side of the battery stack in the first direction D1 and including the side recessed portion. The holder protruding portions may include a first holder protruding portion provided on the holder member, configured to face the first side plate, and protruding in the first direction D1, and a second holder protruding portion provided on the holder member, configured to face the second side plate, and protruding in the first direction D1. The first holder protruding portion may be provided (e.g., accommodated) in the side recessed portion provided in the first side plate, and the second holder protruding portion may be provided (e.g., accommodated) in the side recessed portion provided in the second side plate.

The first holder protruding portion may be fixedly coupled to the first side plate, and the second holder protruding portion may be configured to movable in the first direction D1 relative to the second side plate.

The battery module may further include a side fixing member inserted into the first holder protruding portion and the first side plate.

The second holder protruding portion may be spaced apart from the side recessed portion, which is provided in the second side plate, in the first direction D1.

The side recessed portion may extend to an end of the side plate in the second direction D2.

When a direction intersecting the first direction D1 and the second direction D2 may be a third direction D3, a first side end of each of the plurality of battery cells in the third direction D3 may be i) formed on the same plane, which is parallel to the second direction D2, as one side end of the holder member in the third direction D3 corresponding to the first side end of each of the plurality of battery cells or ii) formed outward, in the third direction D3, of one side end of the holder member in the third direction D3.

The plurality of battery cells may each include a pouch-type exterior material having an internal space, and an electrode stack provided (e.g., accommodated) in the internal space. The pouch-type exterior material may include a pouch body region configured to provide the internal space, and a sealing region formed by attaching partial regions of the pouch-type exterior material and provided to surround a periphery of the pouch body region. The sealing region may include a first sealing region provided at one side of the pouch-type exterior material in the third direction D3, and a second sealing region connected to one side end of the first sealing region in the second direction D2 and protruding in the second direction D2. The sealing region may further include a bat ear section, which protrudes from the pouch body region in the third direction D3. The bat ear section may be provided at one side end of the second sealing region in a direction of the third direction D3 away from the first sealing region, and the bat ear section may be provided at the first side end of each of the plurality of battery cells in the third direction D3.

The plurality of battery cells may each have a lead region protruding outward and (e.g., tightly) attached to the busbar, an overlap region in which at least some of the lead regions of the plurality of battery cells overlap one another may be formed when the lead region is viewed from a location spaced apart from the lead region in the second direction D2. The overlap region may be (e.g., tightly) attached to the busbar.

Some of the lead regions of the plurality of battery cells may be (e.g., tightly) attached to the busbars in a state in which some of the lead regions are spaced apart from the other lead regions in the first direction D1.

Regions of the busbars, to which the lead regions are (e.g., tightly) attached, may be provided on one imaginary plane formed in a direction intersecting the second direction D2.

The holder member may have a holder concave-convex portion provided in a peripheral region of the holder member and having a shape protruding toward the busbar or a shape recessed away from the busbar, and the busbar may have a busbar concave-convex portion provided at a position corresponding to the holder concave-convex portion. The busbar concave-convex portion may have a shape corresponding to the holder concave-convex portion.

The holder member may have a holder clip portion provided in a peripheral region of the holder member and having a shape protruding toward the busbar, and a partial region of the busbar may be provided to overlap the holder clip portion when the holder clip portion is viewed from a location spaced apart from the holder clip portion in the second direction D2.

The holder member may have a plurality of partition wall sections provided inward in the second direction D2 and spaced apart from one another in the first direction D1, and the lead regions may be provided in spaces between the partition wall sections provided adjacent to one another.

The battery module may further include a rib member provided in a space provided in the first direction D1 between the busbar and the holder member.

The busbar may have a busbar penetration hole formed through the busbar in the second direction D2, and the holder member may have a busbar penetration portion extending in the second direction D2 and configured to penetrate the busbar penetration hole.

The busbar may be assembled to an outer surface of the holder member in the second direction D2, and the busbar penetration portion may protrude in the second direction D2 from a body of the holder member.

An outer end of the busbar penetration portion in the second direction D2 may have a shape corresponding to the outer surface of the busbar in the second direction D2.

According to the present disclosure, it is possible to prevent damage to the battery module caused by vibration and impact caused by an external force and minimize a load applied to the cell lead, thereby improving the overall durability of the battery module.

### BRIEF DESCRIPTION OF THE DRAWINGS

FIG. 1 is a perspective view illustrating a battery module according to the present disclosure.

FIG. 2 is a view illustrating a cross-sectional structure made by vertically cutting the battery module according to the present disclosure in a third direction.

FIG. 3 is an enlarged view illustrating a region in which an end cap member, a holder member, and a side plate in FIG. 1 meet together.

FIG. 4 is a view illustrating a state in which the side plate in FIG. 3 is removed.

FIG. 5 is a view illustrating a cross-sectional structure made by vertically cutting the battery module according to the present disclosure in a second direction.

FIG. 6 is a side view of the side plate provided in the battery module according to the present disclosure.

FIG. 7 is a view illustrating a part of a cross-sectional structure made by vertically cutting the battery module according to the present disclosure in a first direction.

FIG. 8 is a side view of a battery cell provided in the battery module.

FIG. 9 is an enlarged view illustrating a bat ear section formed in a second sealing region of the battery cell in FIG. 8.

FIG. 10 is a view illustrating a coupling structure between the holder member and a busbar of the battery module according to the present disclosure.

FIG. 11 is an enlarged view illustrating a partial region in FIG. 10.

FIG. 12 is a view illustrating the holder member and surrounding components thereof in the battery module according to the present disclosure when viewed from below.

FIG. 13 is a view illustrating a holder member, a busbar, and surrounding components thereof provided in a battery module according to another example of the present disclosure.

FIG. 14 is a view illustrating a holder member and a busbar provided in a battery module according to still another example of the present disclosure.

FIG. 15 is an enlarged view illustrating a partial region in FIG. 14.

FIG. 16 is a view illustrating an example of a cross-section of a region in which a busbar penetration hole and a busbar penetration portion illustrated in FIGS. 14 and 15 are coupled.

FIG. 17 is a view illustrating another example of the cross-section of the region in which the busbar penetration hole and the busbar penetration portion illustrated in FIGS. 14 and 15 are coupled.

### DETAILED DESCRIPTION

Hereinafter, a battery module according to the present disclosure will be described with reference to the drawings.

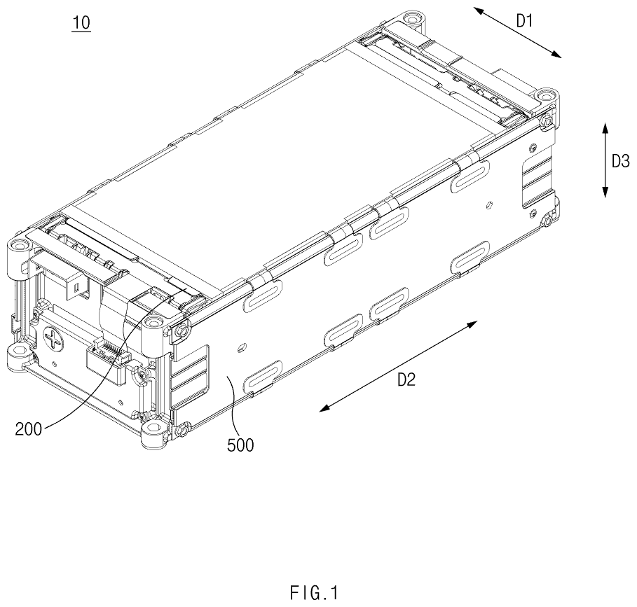

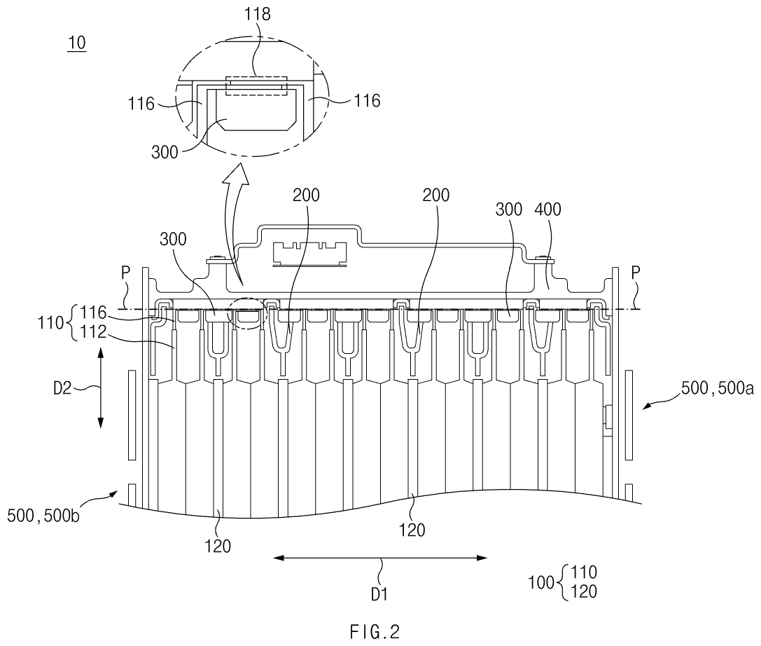

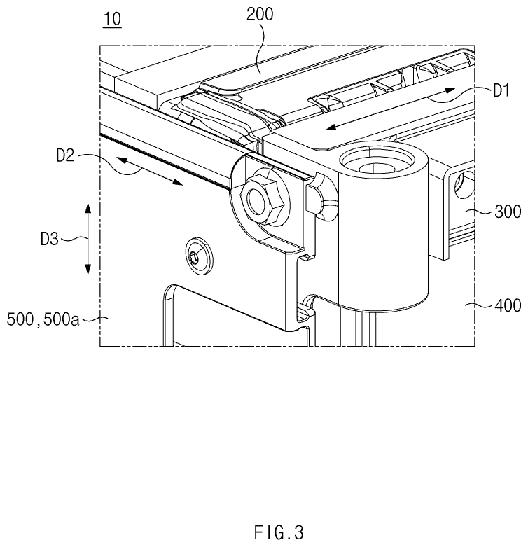

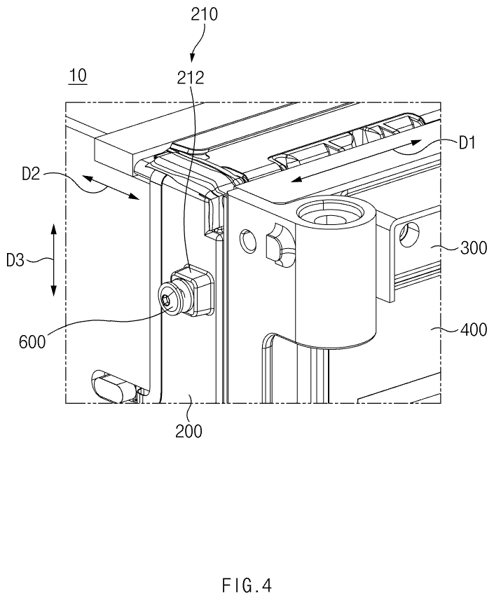

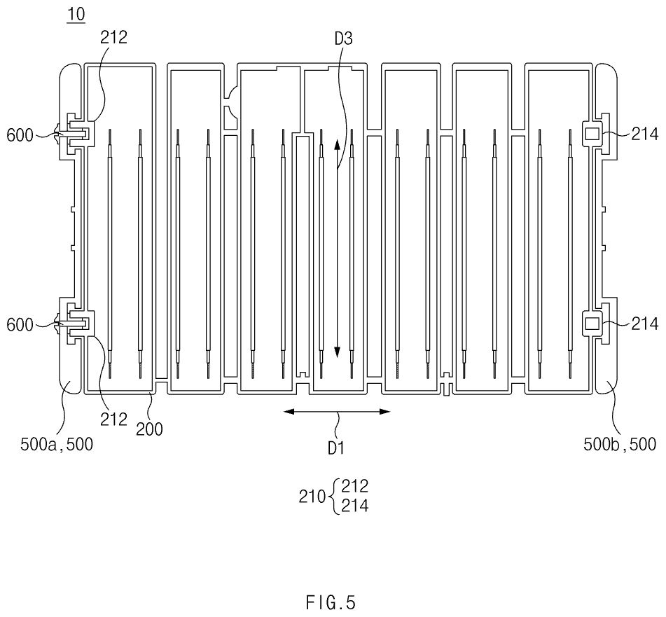

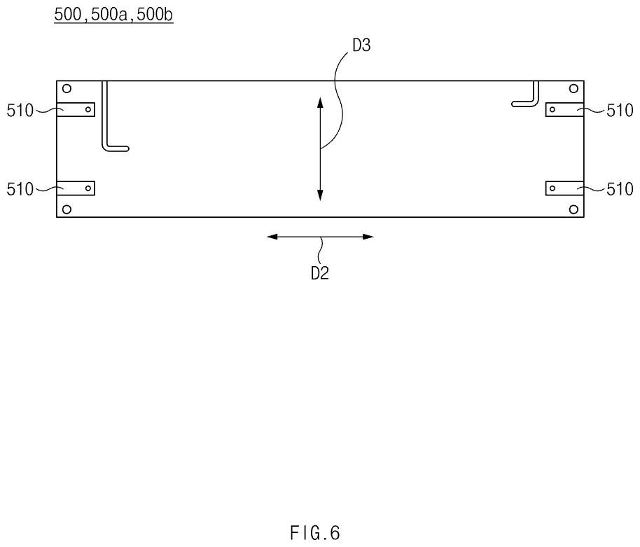

FIG. 1 is a perspective view illustrating a battery module according to the present disclosure, and FIG. 2 is a view illustrating a cross-sectional structure made by vertically cutting the battery module according to the present disclosure in a third direction. FIG. 3 is an enlarged view illustrating a region in which an end cap member, a holder member, and a side plate in FIG. 1 connect (e.g., meet together), and FIG. 4 is a view illustrating a state in which the side plate in FIG. 3 is removed. FIG. 5 is a view illustrating a cross-sectional structure made by vertically cutting the battery module according to the present disclosure in a second direction, and FIG. 6 is a side view of the side plate provided in the battery module according to the present disclosure.

With reference to FIGS. 1 to 6, a battery module 10 according to the present disclosure may include a battery stack 100 including a plurality of battery cells 110 stacked in a first direction D1, and one or more pad members 120 provided between the plurality of battery cells 110. As described below, the battery cell 110 may be a pouch-type secondary battery. In addition, for example, the battery stack 100 may have a structure in which the two battery cells 110 and one pad member 120 are alternately stacked. The pad member 120 may be configured to press the battery cells 110 so that predetermined surface pressure is applied to the battery cells 110 in the battery stack 100.

In addition, the battery module 10 may further include holder members 200 provided at one side of the battery stack 100 in a second direction D2 intersecting the first direction D1, and busbars 300 assembled to the holder members 200 and electrically connected to the battery stack 100. The second direction D2 may perpendicularly intersect the first direction D1. The busbar 300 may be configured to mediate the electrical connection between the battery module 10 and external components.

In addition, the battery module 10 may further include end cap members 400 provided outward of the holder members 200 in the second direction D2, and side plates 500 (e.g., respectively) provided at (e.g., two) opposite sides of the battery stack 100 in the first direction D1. The side plates 500 may be configured to apply predetermined surface pressure to the battery cells 110 by pressing the battery stack 100 inward in the first direction D1. In addition, the side plates 500 and the end cap members 400 may be provided to surround the battery stack 100 and the holder members 200 from the outside.

According to the present disclosure, the battery module may include a configuration for dispersing a load applied to the battery cells 110 in case vibration or impact is applied to the battery module 10 from the outside. For example, as illustrated in FIGS. 2 and 5, the holder member 200 may be provided to be in contact with the side plate 500. As described below, the holder member 200 may be (e.g., indirectly) connected to the battery cell by (e.g., means of) the busbar. Therefore, according to the present disclosure, in a case where vibration or impact is applied to the battery cells 110 by an external force, a load applied to the battery cells 110 may be transmitted to the side plates 500 through the busbars 300 and the holder members 200.

In addition, according to the present disclosure, at least one region of the holder member 200 may be provided inward of the side plate 500 in the second direction D2. In this case, the holder member 200 may have holder protruding portions 210 protruding in the first direction D1 and provided in a region of the holder member 200 inward of the side plate 500 in the second direction D2. The side plate 500 may have side recessed portions 510 having recessed shapes and provided in a region of an inner surface of the side plate 500 provided in the first direction D1 and facing the holder protruding portions 210. In this case, the holder protruding portion 210 may be provided (e.g., accommodated) in the side recessed portion 510. According to the present disclosure, the holder member 200 may be assembled at an (e.g., exact) position based on a relationship with the side plate 500 by the interference between the holder protruding portion 210 and the side recessed portion 510. For example, as illustrated in FIG. 6, the side recessed portion 510 may extend to an end of the side plate 500 in the second direction D2. In this case, in a state in which the holder protruding portions 210 are provided (e.g., accommodated) in the side recessed portions 510, the holder protruding portions 210 may slide in the second direction D2, such that the holder member 200 may be (e.g., smoothly) assembled.

As described above, the side plates 500 may be respectively provided at (e.g., two) opposite sides (e.g., a first side, second side, third side, and/or fourth side) of the battery stack 100 in the first direction D1. Therefore, the two side plates 500 provided in the battery module 10 may be (e.g., respectively) referred to as a first side plate and a second side plate. That is, according to the present disclosure, the side plates 500 may include a first side plate 500a provided at one side of the battery stack 100 in the first direction D1 and including the side recessed portions 510, and a second side plate 500b provided at the other side of the battery stack 100 in the first direction D1 and including the side recessed portions 510. For example, the first side plate 500a and the second side plate 500b may have symmetric shapes.

In addition, the holder protruding portions 210 may include a first holder protruding portion 212 provided on the holder member 200, configured to face the first side plate 500a, and protruding in the first direction D1, and a second holder protruding portion 214 provided on the holder member 200, configured to face the second side plate 500b, and protruding in the first direction D1. In this case, the first holder protruding portion 212 may be provided (e.g., accommodated) in the side recessed portion 510 provided in the first side plate 500a, and the second holder protruding portion 214 may be provided (e.g., accommodated) in the side recessed portion 510 provided in the second side plate 500b.

According to the present disclosure, one side of the holder member 200 may be (e.g., fixedly) coupled to the side plate 500. For example, the first holder protruding portion 212, among the holder protruding portions, may be (e.g., fixedly) coupled to the first side plate 500a, and the second holder protruding portion 214, among the holder protruding portions, may not be (e.g., fixedly) coupled to the second side plate 500b. That is, the second holder protruding portion 214 may be configured to move (e.g., be movable) in the first direction D1 relative to the second side plate 500b.

As illustrated in FIGS. 4 and 5, in order to allow the first holder protruding portions 212 and the first side plate 500a to be (e.g., fixedly) coupled, the battery module 10 may further include side fixing members 600 inserted into the first holder protruding portions 212 and the first side plate 500a. For example, the first side plate 500a may have through-holes, the first holder protruding portions 212 may have through-holes or recessed portions, and the side fixing members 600 may penetrate the first side plate 500a and be inserted into the first holder protruding portions 212. The side fixing member 600 may be a bolt member or a screw member. In contrast, as illustrated in FIG. 5, the second holder protruding portion 214 may be spaced apart from the side recessed portion 510, which is provided in the second side plate 500b, in the first direction D1.

In a case that the holder members 200 are (e.g., fixedly) coupled to the first side plate 500a and provided to be movable relative to the second side plate 500b as described above, the holder members 200 may move in a thickness direction of the battery cell 110, (e.g., the first direction D1) while accommodating (e.g., coping) with a situation in which the thickness of the battery stack 100 is changed when the battery cell 110 swells in the battery stack 100. Therefore, it is possible to minimize a load applied to the holder members 200 when the thickness of the battery stack 100 is changed.

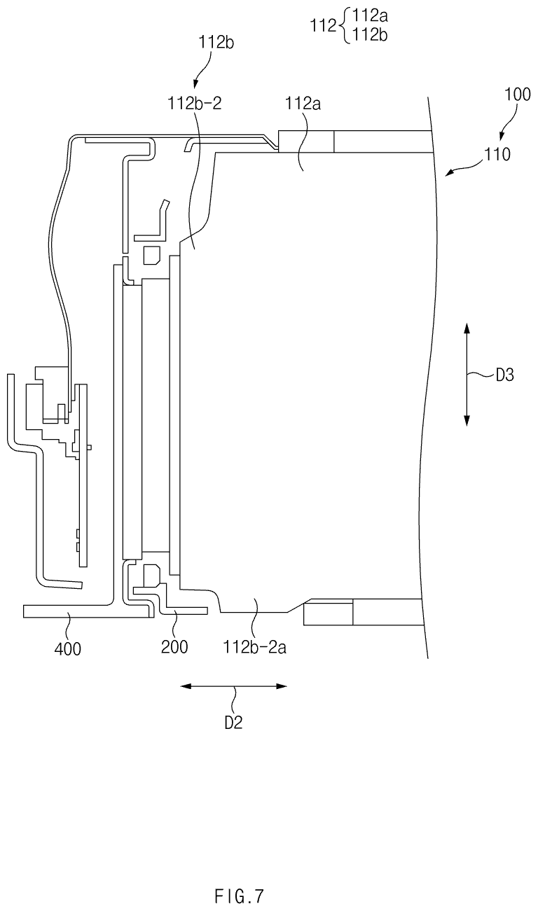

FIG. 7 is a view illustrating a part of a cross-sectional structure made by vertically cutting the battery module according to the present disclosure in the first direction. Hereinafter, a direction intersecting the first direction D1 and the second direction D2 is provided as a third direction D3. For example, the third direction D3 may perpendicularly intersect the first direction D1 and the second direction D2. The third direction D3 may be an upward/downward direction in FIGS. 1 to 7.

The battery module 10 according to the present disclosure may have a structure capable of minimizing a width in the third direction D3. For example, with reference to FIG. 7, a first side end (e.g., a lower end in FIG. 7) of each of the plurality of battery cells 110 in the third direction D3 i) may be formed on the same plane, which is parallel to the second direction D2, as one side end (a lower end in FIG. 7) of the holder member 200, which is provided in the third direction D3 and corresponds to the first side end of each of the plurality of battery cells 110, or ii) may be formed outward (e.g., downward) in the third direction D3 from one side end of the holder member 200 in the third direction D3.

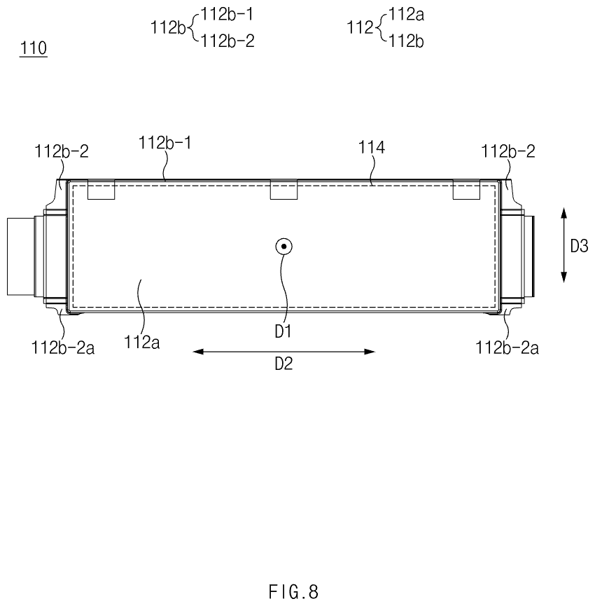

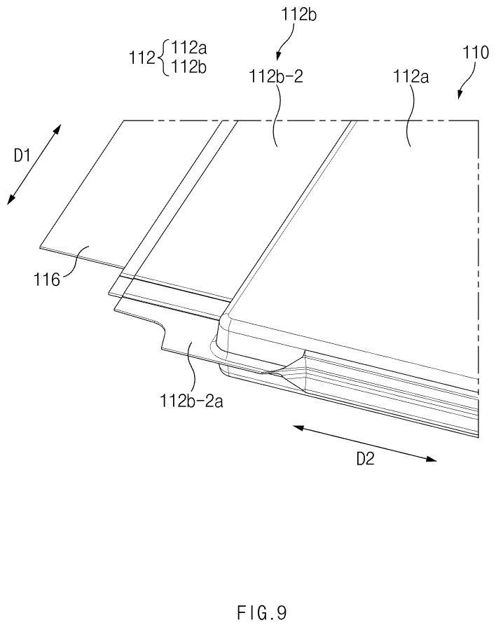

FIG. 8 is a side view of the battery cell provided in the battery module, and FIG. 9 is an enlarged view illustrating a bat ear section formed in a second sealing region of the battery cell in FIG. 8.

With reference to FIG. 8, the plurality of battery cells 110 provided in the battery stack 100 according to the present disclosure may each include a pouch-type exterior material 112 having an internal space, and an electrode stack 114 provided (e.g., accommodated) in the internal space. That is, according to the present disclosure, the battery cell 110 may be a pouch-type secondary battery. The electrode stack 114 has a structure in which electrodes and separators are alternately stacked. Because the electrode stack 114 is widely known in the field of secondary batteries, a detailed description thereof will be omitted.

As described above, the pouch-type exterior material 112 may be divided into a plurality of regions. For example, as illustrated in FIG. 8, the pouch-type exterior material 112 may include a pouch body region 112a configured to provide the internal space, and a sealing region 112b formed by attaching partial regions of the pouch-type exterior material 112 and provided to surround a periphery of the pouch body region 112a. The sealing region 112b may be configured to seal the internal space from the outside.

In addition, the sealing region 112b may include a first sealing region 112b-1 formed at one side of the pouch-type exterior material 112 in the third direction D3, and second sealing regions 112b-2 connected to one side end of the first sealing region 112b-1 in the second direction D2 and protruding in the second direction D2. For example, the first sealing region 112b-1 may be provided (e.g., only) at one side of the pouch-type exterior material 112 in the third direction D3 without being provided at the other side of the pouch-type exterior material 112 in the third direction D3. In FIG. 8, the first sealing region 112b-1 may be formed in an upper peripheral region of the pouch-type exterior material 112. The second sealing regions 112b-2 may be respectively provided at two opposite side ends of the first sealing region 112b-1 in the second direction D2. In this case, the sealing region 112b may have an approximately “U” shape that surrounds the peripheral region of the pouch body region 112a.

With continued reference to FIGS. 8 and 9, bat ear sections 112b-2a may be provided at one side end of the second sealing region 112b-2 in a direction of the third direction D3 away from the first sealing region 112b-1, and the bat ear sections 112b-2a may protrude from the pouch body region 112a in the third direction D3.

The bat ear section 112b-2a may be a region formed during a process of forming the pouch-type exterior material 112 having the internal space formed by joining partial regions of a pouch-type sheet. For example, the pouch-type exterior material 112 may be formed by forming a recessed region by forming the partial regions of the pouch-type sheet and then attaching peripheral regions of the recessed region. In this case, the bat ear section 112b-2a may be a section geometrically created because a thickness of the regions (e.g., the sealing regions) of the pouch-type exterior material 112, which are joined to each other, is relatively small, whereas a thickness of the region (e.g., the pouch body region) of the pouch-type exterior material 112, which provides the internal space, is relatively large.

In this case, as illustrated in FIGS. 7 and 8, the bat ear sections 112b-2a may be provided at the first side end (the lower end in FIG. 7) of each of the plurality of battery cells in the third direction D3.

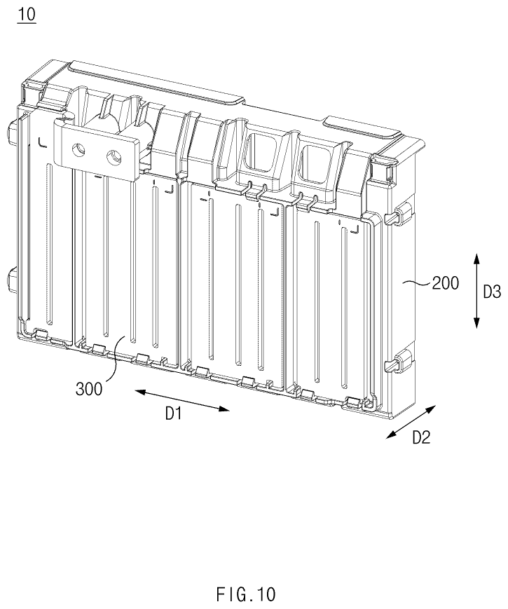

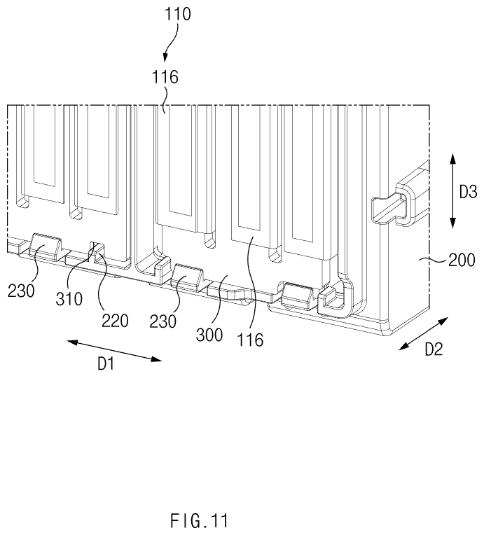

FIG. 10 is a view illustrating a coupling structure between the holder member and the busbar of the battery module according to the present disclosure, and FIG. 11 is an enlarged view illustrating a partial region in FIG. 10.

With reference to FIGS. 2, 10, and 11, the plurality of battery cells 110 may have lead regions 116 protruding outward, (e.g., tightly) attached to the busbars 300, and electrically connected to the busbars 300. For example, as illustrated in FIG. 2, the lead region 116 may include a first section configured to penetrate the busbar 300 and protruding in the second direction D2, and a second section bent in the first direction D1 from the first section and (e.g., tightly) attached to an outer surface of the busbar 300 in the second direction D2. For example, the battery cell 110 may extend in the second direction D2 as the longitudinal direction, and the lead region 116 may be provided at an end of each of the plurality of battery cells 110 in the second direction D2. For example, the busbar 300 and the lead region 116 may be fixed to each other by welding. As described above, the battery cell 110 may be a pouch-type secondary battery, and the lead region 116 may protrude to the outside through the above-mentioned second sealing region 112b-2.

As illustrated in FIGS. 2, 10, and 11, according to the present disclosure, when the lead region 116 is viewed from a location spaced apart from the lead region 116 in the second direction D2, there may be overlap regions 118 in which at least some of the lead regions 116 of the plurality of battery cells 110 are provided to overlap one another. The overlap region 118 may be (e.g., tightly) attached to the busbars 300. For example, the overlap region 118 may be welded to the busbar 300. Therefore, in the regions in which the overlap regions 118 are fixed to the busbars 300, some of the plurality of lead regions 116, which provide the overlap regions 118, may be (e.g., tightly) attached (e.g., directly) to the busbars 300, and some of the other lead regions 116, which provide the overlap regions 118, may be provided to face the busbars 300 with the lead regions 116, which are (e.g., tightly) attached (e.g., directly) to the busbars 300, interposed therebetween. For example, the above-mentioned overlap region 118 may be formed (e.g., only) at one position at one side of the battery module 10 in the second direction D2. Because one of the two lead regions 116, which provide the overlap region 118, is provided to face the busbar 300 with the other lead region 116 interposed therebetween, one lead region 116 may not be (e.g., technically) considered as being (e.g., tightly) attached to the busbar 300. However, in the present specification, both the two lead regions 116, which provide the overlap region 118, are provided as being (e.g., tightly) attached to the busbar 300.

As described above, according to the present disclosure, some of the plurality of lead regions 116 may be electrically connected to the busbars 300 through the overlap regions 118, such that the busbar 300 may have a flat shape (e.g., as a whole) without having a bent shape. That is, a width of the battery stack 100 in the first direction D1 and a width of the busbar 300 in the first direction D1 may correspond to the width of the battery stack 100. In this case, according to the present disclosure, some of the lead regions 116 of the battery cells 110, which constitute the battery stack 100, provide the overlap regions 118 and then are connected to the busbars 300. Therefore, the electrical connection between the lead regions 116 and the busbars 300 may be provided without bending two opposite ends of the busbar 300 in the second direction D2 and then (e.g., tightly) attaching the lead regions 116 of the battery cells 110, which are disposed at two opposite ends in the second direction D2, to the two opposite bent ends of the busbar 300.

According to the present disclosure, some of the other lead regions 116 of the plurality of battery cells 110, which may exclude the components for defining the overlap regions 118, may be (e.g., tightly) attached to the busbars 300 while being spaced apart from the other lead regions in the first direction D1.

With reference to FIGS. 10 and 11, the holder member 200 of the battery module 10 according to the present disclosure may have a holder concave-convex portion 220 provided in a peripheral region of the holder member 200 and having a shape protruding toward the busbar 300 or a shape recessed away from the busbar 300. FIGS. 10 and 11 illustrate states in which the holder concave-convex portion 220 protrudes toward the busbar 300.

In addition, in order to correspond to the shape of the holder concave-convex portion 220, the busbar 300 may have a busbar concave-convex portion 310 formed at a position corresponding to the holder concave-convex portion 220, and the busbar concave-convex portion 310 may have a shape corresponding to the holder concave-convex portion 220. The configuration in which the busbar concave-convex portion 310 has the shape corresponding to the holder concave-convex portion 220 may be i) a configuration in which the busbar concave-convex portion 310 has a recessed shape when the holder concave-convex portion 220 has a protruding shape, and ii) a configuration in which the busbar concave-convex portion 310 has a protruding shape when the holder concave-convex portion 220 has a recessed shape. The holder concave-convex portion 220 and the busbar concave-convex portion 310 may be configured to dispose the busbar 300 at an (e.g., exact) position during assembly of the busbar 300 to the holder member 200. Because the holder concave-convex portion 220 and the busbar concave-convex portion 310 have corresponding shapes, a relative movement between the busbar 300 and the holder member 200 in the first direction D1 may be limited (e.g., restricted) by interference between the holder concave-convex portion 220 and the busbar concave-convex portion 310. However, because the holder concave-convex portion 220 and the busbar concave-convex portion 310 are not (e.g., fixedly) coupled to each other, the busbar 300 may move by a predetermined distance in the thickness direction of the battery cell 110, e.g., relative to the holder member 200 in the first direction D1 while providing for a change in thickness of the battery stack 100 when the battery cell 110 swells in the battery stack 100. Therefore, it is possible to minimize a load applied to the holder member 200 in accordance with the change in thickness of the battery stack 100.

In addition, the holder member 200 may have a holder clip portion 230 provided in a peripheral region of the holder member 200 and having a shape protruding toward the busbar 300. The holder clip portion 230 may be configured to (e.g., substantially) prevent the busbar 300 from being withdrawn from the holder member 200 after the busbar 300 is assembled to the holder member 200. When the holder clip portion 230 and the surrounding components thereof are viewed from a location spaced apart from the holder clip portion 230 and the surrounding components thereof in the second direction D2, a partial region of the busbar 300 may be provided to overlap the holder clip portion 230. Therefore, according to the present disclosure, in case that the busbar 300 is about to move outward from the holder member 200 in the second direction D2, the state in which the busbar 300 is assembled to the holder member 200 may be maintained by interference between the busbar 300 and the holder clip portion 230. The holder clip portion 230 may have a clip or hook shape, which may be deformed when an external force is applied inward in the second direction D2, so that the busbar 300 may push the holder clip portion 230 and be seated on the holder member 200 during the process of assembling the busbar 300 to the holder member 200.

As illustrated in FIGS. 2, 10, and 11, according to the present disclosure, the busbar 300 may have a flat shape (e.g., as a whole). For example, according to the embodiment of the present disclosure, the regions of the busbars 300 to which the lead regions 116 are (e.g., tightly) attached may be provided on one imaginary plane P formed in a direction perpendicularly intersecting the second direction D2. For example, the entire outer surface of the busbar 300 in the second direction D2 may be provided on an (e.g., one) imaginary plane P formed in the direction perpendicularly intersecting the second direction D2.

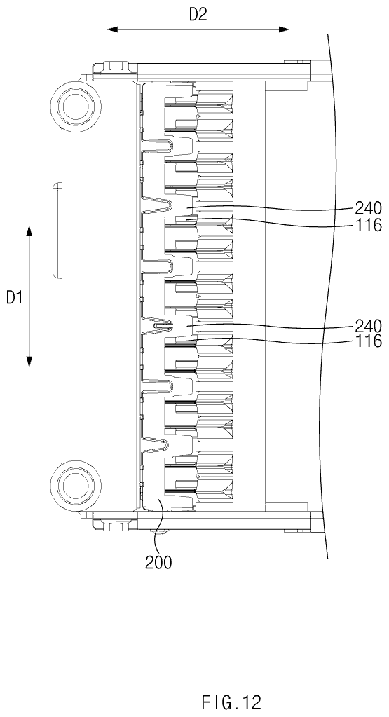

FIG. 12 is a view illustrating the holder member and surrounding components thereof in the battery module according to the present disclosure when viewed from below.

With reference to FIGS. 2 and 12, the holder member 200 may have a plurality of partition wall sections 240 provided inward in the second direction D2 and spaced apart from one another in the first direction D1. In this case, the lead regions 116 may be provided in spaces between the partition wall sections 240 provided adjacent to one another. The partition wall section 240 may be configured to support the busbar while providing (e.g., ensuring) insulation between the adjacent cells.

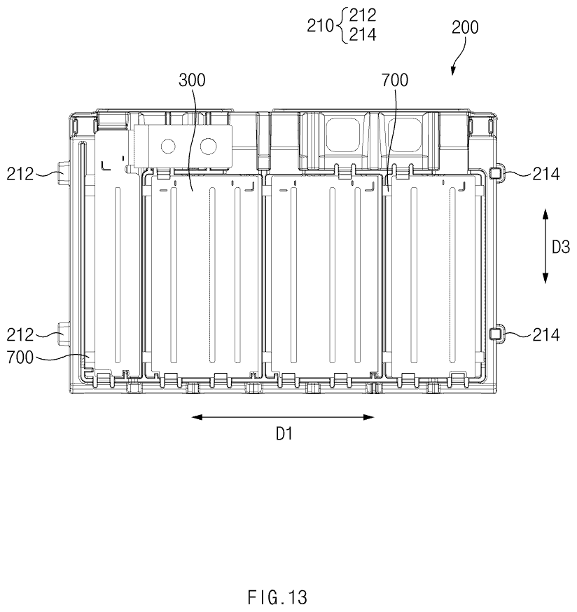

FIG. 13 is a view illustrating a holder member, a busbar, and surrounding components thereof provided in a battery module according to another example of the present disclosure.

As illustrated in FIG. 13, according to another example of the present disclosure, the battery module 10 may further include rib members 700 provided in spaces provided in the first direction D1 between the busbar 300 and the holder member 200. The rib member 700 may be configured to restrict the movement between the busbar 300 and the holder member 200 in the first direction D1 within a predetermined range. That is, in a case that a distance of the movement between the busbar 300 and the holder member 200 in the first direction D1 exceeds a predetermined value, the busbar 300 or the holder member 200 interferes with the rib member 700 and the movement between the busbar 300 and the holder member 200 in the first direction D1 may be restricted. The rib member 700 may have a shape protruding from one side surface of the holder member 200 in the first direction D1, and the rib member 700 may be spaced apart from the busbar 300 in the first direction D1. However, alternatively, the rib member 700 may have a shape protruding from one side surface of the busbar 300 in the first direction D1, and the rib member 700 may be spaced apart from the holder member 200 in the first direction D1.

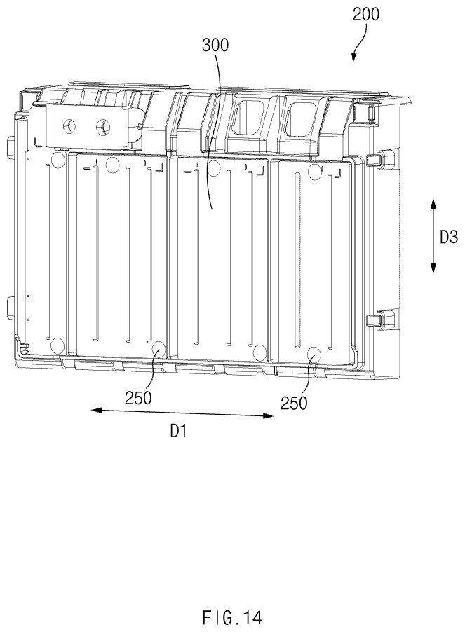

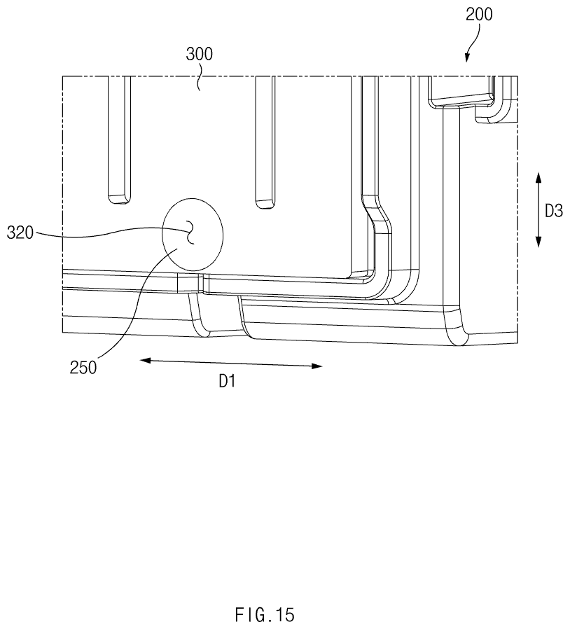

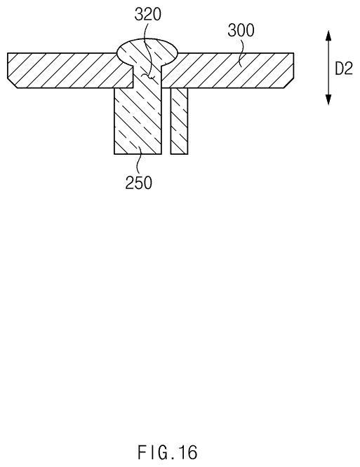

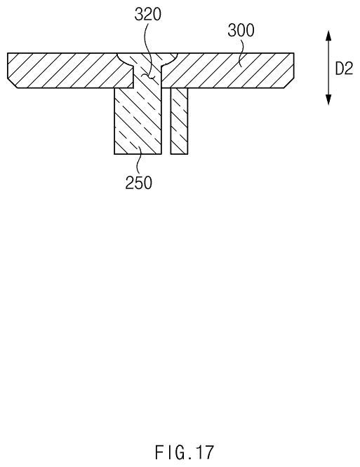

FIG. 14 is a view illustrating a holder member and a busbar provided in a battery module according to still another example of the present disclosure, and FIG. 15 is an enlarged view illustrating a partial region in FIG. 14. FIG. 16 is a view illustrating an example of a cross-section of a region in which a busbar penetration hole and a busbar penetration portion illustrated in FIGS. 14 and 15 are coupled, and FIG. 17 is a view illustrating another example of the cross-section of the region in which the busbar penetration hole and the busbar penetration portion illustrated in FIGS. 14 and 15 are coupled.

With reference to FIGS. 14 and 15, in the battery module 10 according to still another example of the present disclosure, the busbar 300 and the holder member 200 may be (e.g., fixedly) coupled to each other. For example, the busbar 300 may have a busbar penetration hole 320 formed through the busbar 300 in the second direction D2, and the holder member 200 may have a busbar penetration portion 250 extending in the second direction D2 and configured to penetrate the busbar penetration hole 320. For example, the busbar 300 may be assembled to an outer surface of the holder member 200 in the second direction D2, and the busbar penetration portion 250 may protrude outward from a body of the holder member 200 in the second direction D2 and be inserted into the busbar penetration hole 320. The busbar penetration portion 250 may be inserted into the busbar penetration hole 320 and then fixed by thermal bonding.

As illustrated in FIG. 16, an outer end of the busbar penetration portion 250 in the second direction D2 may have a shape protruding in the second direction D2 from the outer surface of the busbar 300 in the second direction D2. However, alternatively, as illustrated in FIG. 17, the outer end of the busbar penetration portion 250 in the second direction D2 may have a shape corresponding to the outer surface of the busbar 300 in the second direction D2. This configuration may be such that a flat shape is formed, instead of a stepped portion, on a boundary between the outer end of the busbar penetration portion 250 in the second direction D2 and the peripheral region of the busbar penetration hole 320 of the busbar 300. In this case, a contact area between the busbar 300 and a thermally conductive sheet attached to the outer surface of the busbar 300 in the second direction D2 may be maximized, such that the busbar may be more (e.g., smoothly) cooled.

The present disclosure has been described with reference to the limited embodiments and the drawings, but the present disclosure is not limited thereby. The present disclosure may be carried out in various forms within the technical spirit of the present disclosure and the scope equivalent to the appended claims.

What is claimed is:

1. A battery module comprising:
a battery stack including a plurality of battery cells stacked in a first direction, and at least one pad member provided between the plurality of battery cells;
a holder member provided at a side of the battery stack in a second direction, wherein the second direction intersects the first direction;
at least one busbar coupled to the holder member and electrically connected to the battery stack;
an end cap member provided outward of the holder member in the second direction; and
a side plate provided on a side of the battery stack, wherein the side plate is in the first direction,
wherein the holder member is provided to be in contact with the side plate.

2. The battery module of claim 1, wherein a side of the holder member is coupled to the side plate.

3. The battery module of claim 2,
wherein at least one region of the holder member is provided inward of the side plate in the second direction,
wherein the holder member has a holder protruding portion protruding in the first direction and provided in a region of the holder member inward of the side plate in the second direction,
wherein the side plate has a side recessed portion having a recessed shape provided in a region of an inner surface of the side plate provided in the first direction and provided to face the holder protruding portion, and
wherein the holder protruding portion is provided in the side recessed portion.

4. The battery module of claim 3, wherein the side plate includes:
a first side plate provided at a side of the battery stack in the first direction and including the side recessed portion; and
a second side plate provided at a side of the battery stack in the first direction and including the side recessed portion,
wherein the holder protruding portion includes
a first holder protruding portion provided on the holder member, configured to face the first side plate and protrude in the first direction, and
a second holder protruding portion provided on the holder member, configured to face the second side plate and protrude in the first direction,
wherein the first holder protruding portion is provided in the side recessed portion provided in the first side plate, and
wherein the second holder protruding portion is provided in the side recessed portion provided in the second side plate.

5. The battery module of claim 4, wherein the first holder protruding portion is coupled to the first side plate, and the second holder protruding portion is configured to move in the first direction relative to the second side plate.

6. The battery module of claim 5, further comprising:
a side fixing member inserted into the first holder protruding portion and the first side plate.

7. The battery module of claim 6, wherein the second holder protruding portion is spaced apart from the side recessed portion provided in the second side plate in the first direction.

8. The battery module of claim 3, wherein the side recessed portion extends to an end of the side plate in the second direction.

9. The battery module of claim 1,
wherein each of the plurality of battery cells includes a first side end in a third direction, wherein the third direction intersects the first direction and the second direction, the first side end is formed in the same plane as a side end of the holder member in the third direction, or the first side end is formed outward, in the third direction, of a side end of the holder member in the third direction.

10. The battery module of claim 9, wherein each battery cell of the plurality of battery cells includes:
a pouch-type exterior material having an internal space; and
an electrode stack provided in the internal space,
wherein the pouch-type exterior material includes
a pouch body region configured to provide the internal space, and
a sealing region formed by attaching partial regions of the pouch-type exterior material and surrounding a periphery of the pouch body region, wherein the sealing region includes
a first sealing region provided at a side of the pouch-type exterior material in the third direction, and
a second sealing region connected to a side end of the first sealing region in the second direction and protrudes in the second direction,
wherein a bat ear section protrudes from the pouch body region in the third direction and is provided at an end of the second sealing region in the third direction.

11. The battery module of claim 1, wherein each battery cell of the plurality of battery cells has a lead region protruding outward and is attached to the busbar,
wherein, when the lead region is viewed from a location spaced apart from the lead region in the second direction, an overlap region is formed when a lead region of the a battery cell of the plurality of battery cells overlaps with another lead region of another battery cell of the plurality of battery cells, and
wherein the overlap region is attached to the busbar.

12. The battery module of claim 11, wherein at least one lead region of the battery cell of the plurality of battery cells is attached to the busbar, and wherein at least one lead region is spaced apart from at least one other lead region in the first direction.

13. The battery module of claim 11, wherein a region of the busbar to which the lead region is attached is provided on an imaginary plane formed in a direction intersecting the second direction.

14. The battery module of claim 11,
wherein the holder member has a holder concave-convex portion provided in a peripheral region of the holder member, and the holder concave-convex portion has a shape protruding toward the busbar or a shape recessed away from the busbar, and
wherein the busbar has a busbar concave-convex portion provided at a position corresponding to the holder concave-convex portion, and the busbar concave-convex portion has a shape corresponding to the holder concave-convex portion.

15. The battery module of claim 11,
wherein the holder member has a holder clip portion provided in a peripheral region of the holder member, and the holder clip portion has a shape protruding toward the busbar, and
wherein a partial region of the busbar is provided to overlap the holder clip portion when the holder clip portion is viewed from a location spaced apart from the holder clip portion in the second direction.

16. The battery module of claim 11,
wherein the holder member has a plurality of partition wall sections provided inward in the second direction and the plurality of partition wall sections are spaced apart from one another in the first direction, and
wherein the lead region is provided in a space between the partition wall section and an adjacent partition wall section.

17. The battery module of claim 1, further comprising:
a rib member provided in a space provided in the first direction between the busbar and the holder member.

18. The battery module of claim 1, wherein the busbar has a busbar penetration hole formed through the busbar in the second direction, and the holder member has a busbar penetration portion extending in the second direction and configured to penetrate the busbar penetration hole.

19. The battery module of claim 18, wherein the busbar is coupled to an outer surface of the holder member in the second direction, and the busbar penetration portion protrudes in the second direction from a body of the holder member.

20. The battery module of claim 19, wherein an outer end of the busbar penetration portion in the second direction has a shape corresponding to the outer surface of the busbar in the second direction.
